(19) United States
(12) Patent Application Publication
(10) Pub. No.: US 2011/0107926 A1
(43) Pub. Date: May 12, 2011

(54) Non-Apertured Media Embossing Template

(75) Inventor: J. Michael Dywan, Phoenix, AZ (US)

(73) Assignee: PMA PHOTOMETALS OF ARIZONA, INC., Phoenix, AZ (US)

(21) Appl. No.: 12/615,144

(22) Filed: Nov. 9, 2009

(51) Int. Cl. B44B 5/02

(52) U.S. Cl. 101/28

(57) ABSTRACT

A non-apertured media embossing template (24) is formed from a non-apertured die (20). Media embossing template (24) has a raised perimeter (32) and a recessed embosser (34). The raised perimeter (32) is a two-dimensional embossing perimeter integrally formed with a face of non-apertured die (20). Raised perimeter (32) can be used to emboss and/or cut a media (26), based upon the amount of force (28) applied to press media (26) onto non-apertured die (20). Recessed embosser (34) has an embossing pattern that can be used to further emboss media (26), providing either a uniform pattern for embossment on media (26), or further detail associated with raised perimeter (32).

### TECHNICAL FIELD OF THE INVENTION

The present invention relates to the field of media embellishment. More specifically, the present invention relates to media embellishing templates.

### BACKGROUND OF THE INVENTION

Papercraft and scrapbooking have become increasingly popular over the past many years. Many people have used the art of scrapbooking to collect and organize photographs and other mementos in ways that personalize the collections. Much of this personalization is done through the use of embellishments which are often created using templates that cut and/or emboss the media used.

Traditional press systems that use these embossment and embellishment templates utilize a two-piece die system. These traditional systems use two complementing dies such that one die has a male die having an embossing surface with raised areas and a female die that has complementary recessed areas such that the recessed areas of the female die can receive the raised areas of the male die if the dies are pressed together. In these traditional systems, the media is placed between the male and female dies, and the male and female dies are pressed together to emboss the media.

Some traditional single-die templates use apertures formed into the template to provide secondary embellishments to a pattern. In such systems, the template has both raised areas and apertures. The raised areas emboss and/or cut the media when pressure is applied. When sufficient pressure is applied, the media is further pressed into the apertures, forming a secondary embossment. These systems require control over the pressure used to press the media on the template, as an increase in the pressure may impose unwanted embellishments upon the media. The effects of this are apparent in situations where the user desires to only cut the media with the raised areas; however the pressure required to cut the media with these templates results in the unwanted side effect of additional embossment by the apertures.

The traditional single-die templates are often very thin, ranging between 0.010 inches to about 0.060 inches. The thinness reduces the time and materials needed to formulate the apertures within the single die template. However, the resultant die template often has sharp edges that may inadvertently cut media while being set up, and also may harm individuals using the die, as the sharp nature of the edges, both on the side and within the apertures, may cut skin

Also, when a media is pressed into traditional die templates that cut the media, the media is pressed into the die, and abuts the cutting surface of the die on all sides of the cutting surface. To remove the media from the die template, traditionally a pick or other tool is used to lift a portion of the media from within the cut area, and then remove the media by pulling on the lifted portion. Due to the closeness of the media and the cutting surface, the pick or other tool is traditionally a sharp pointed device.

In addition to embossing media, papercraft and scrapbooking utilize colors and paints to personalize media and collections. In the event that users wish to embellish specific areas of their pressed media, often embellishments must be added, and the media colored and/or painted subsequent to pressing. Especially in traditional single-die templates, embellishments may be made only specific areas of the die, and thus to the media, while on the template being embossed. It is not possible for users to color and/or paint the full figure while also embossing the media, better ensuring accurate coloring and/or painting of media with regards to the embossment pattern being imposed on media.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a side view of a non-apertured die in accordance with a preferred embodiment of the present invention;

FIG. 2 shows a perspective view of a face of a non-apertured die in accordance with a preferred embodiment of the present invention; and

FIG. 3 shows a perspective view of a face of a non-apertured die in accordance with an alternate embodiment of the present invention.

### DETAILED DESCRIPTION OF THE PREFERRED EMBODIMENTS

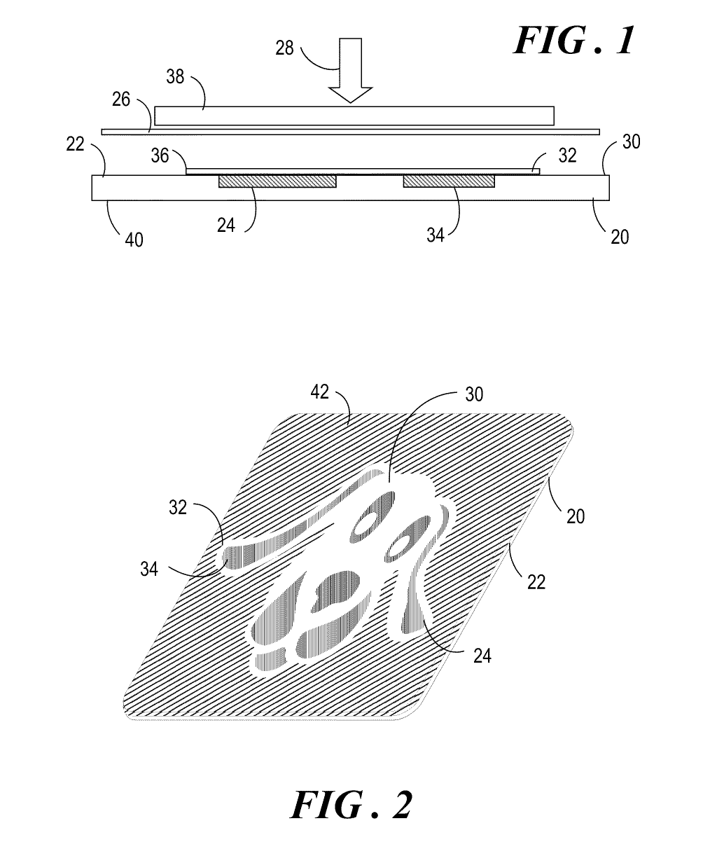

FIG. 1 is a side view of a non-apertured die 20. Non-apertured die 20 has a face 22 with a media embossing template 24 impressed upon face 22. Media embossing template 24 is a template which can be used to cut and/or emboss and otherwise embellish a media 26. In order to mold media 26 to conform to media embossing template 24 on non-apertured die 20, a force 28 is placed on media 26, pressing media 26 onto non-apertured die 20. Force 28 upon media 26, as it is pressed onto face 22 of non-apertured die 20, will cause media 26 to conform to media embossing template 24. Media embossing template 24 is imprinted upon face 22 of non-apertured die 20 by etching, machining, or otherwise removing of unwanted layers of face 22. Because media embossing template 24 will have media 26 pressed onto it, non-apertured die 20 must be formed from a material that is able to withstand force 28 that may be imposed upon it. In one embodiment, non-apertured die 20 is made from a metal.

Media embossing template 24 comprises a template base 30, a raised perimeter 32 and a recessed embosser 34. Raised perimeter 32 and recessed embosser 34 are raised and recessed relative to template base 30. Raised perimeter 32 defines an outer perimeter for the figure or pattern that media embossing template 24 depicts. Raised perimeter 32 is a two-dimensional perimeter that is integrally formed with face 22, and raised from face 22 relative to template base 30. When media 26 is pressed onto face 22, raised perimeter 32 will emboss media 26 by impressing into media 26 the pattern or figure defined by raised perimeter 32. In one embodiment, the edge 36 of raised perimeter 32 distal to face 22 is a die-cut blade designed to cut media 26 when media 26 is pressed onto face 22 with sufficient force 28.

Recessed embosser 34 is an embossing pattern confined within the area defined by raised perimeter 32. Recessed embosser 34 is recessed into face 22 relative to template base 30, and provides embossments that can be pressed into media 26 when sufficient force 28 is applied such that media 26 is pressed into recessed embosser 34. Recessed embosser 34 may be a uniform pattern imprinted upon face 22 within the area confined by raised perimeter 32. In an alternate embodiment, recessed embosser 34 is a pattern that provides additional embellishments to media 26 when pressed into media embossing template 24, such as additional details for the figure or pattern that raised perimeter 32 defines. In one embodiment, a force distribution media 38 is placed on the surface of media 26 distal to face 22. In one embodiment, force distribution media 38 is a solid plate that will not mold to media embossing template 24. In an alternate embodiment, force distribution media 38 includes a spongy material that will conform to the shape of media embossing template 24. In this embodiment, media 26 is placed between the spongy material of force distribution media 38 and face 22 of non-apertured die 20. Force 28 is applied to the surface of force distribution media 38 distal to media 26. Force 28 will cause force distribution media 38 to push media 26 into recessed embosser 34, embossing media 26 with the pattern of recessed embosser 34. In one embodiment, force distribution media 38 includes a rubber media.

One skilled in the art will recognize that although media embossing template 24 has been placed upon face 22 of non-apertured die 20, non-apertured die 20 has a second face 40, and a second media embossing template may be placed upon second face 40 of non-apertured die 20. If a media embossing template is placed upon second face 40, the pattern may be a complement to media embossing template 24 on face 22. In an alternate embodiment, the pattern on second face 40 is unrelated to media embossing template 24 found on face 22 of non-apertured die 20.

FIG. 2 is a perspective view of non-apertured die 20 with the use of a foam or other substance 42 disposed surrounding raised perimeter 32. Foam or other substance 42 may be used to surround raised perimeter 32 and extend from face 22 of non-apertured die 20 to the edge 36 of raised perimeter 32. Foam or other substance 42 can serve as a guard against potential injury a user may suffer if raised perimeter 32 is a die cut blade. Also, foam or other substance 42 can serve to alter media embossing template 24 so that the area of face 22 not enclosed by raised perimeter 32 is aligned with the edge 36 of raised perimeter 32. This will result in a different embossment of media 26 (shown in FIG. 1), as the area of media 26 that is pressed onto the area of face 22 not enclosed by raised perimeter 32 will not be aligned with template base 30. Thus, when force 28 (shown in FIG. 1) is applied to media 26, media 26 will conform to the shape defined by raised perimeter 32 within the area enclosed by raised perimeter 32, however will not be altered in the area outside the area enclosed by raised perimeter 32.

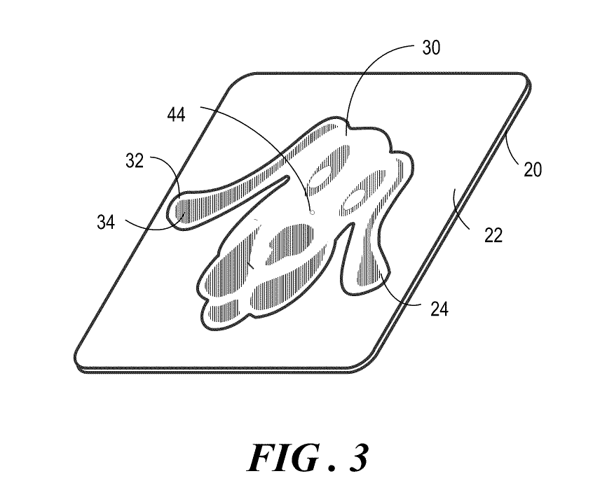

FIG. 3 is a perspective view of non-apertured die 20 showing media embossing template 24 on face 22. Raised perimeter 32 can take the form of any two-dimensional perimeter that defines any figure or pattern that may be desired. One skilled in the art will recognize that although FIG. 2 shows a template of a dog's face, any figure or pattern may be imprinted to form media embellishing template 24 upon non-apertured die 20. In the embodiment shown in FIG. 2, raised perimeter 32 defines the outer circle of dog's face template imprinted on face 22. Recessed embosser 34 provides additional embossing and embellishing features that can be used to provide more detail to media 26. In the embodiment shown in FIG. 2, recessed embosser 34 provides additional details such as the eyes, mouth and ears of dog's face template. As discussed above, recessed embosser 34 is not limited to embossing media 26 (shown in FIG. 1) with such details, rather recessed embosser 34 may also be imprinted with a uniform pattern (not shown), which will provide a uniform pattern over the area of media 26 that is embellished and embossed by media embossing template 24.

In one embodiment, non-apertured die 20 also includes a media release 44. When media is pressed into face 22 and cut by raised perimeter 32, media 26 fits within the area enclosed by raised perimeter 32. Media release 44 is a hole that passes through non-apertured die 20 that permits a user to push media 26 out of media embossing template 24 without using a pick or similar tool (not shown). Media release 44 is positioned and sized so as to not emboss media 26 when media 26 is pressed into media embossing template 24 while still providing a point from which to push media 26 out of media embossing template 24.

By providing a tri-level embossing system, non-apertured die 20 can provide a user with multiple options to emboss media 26 (shown in FIG. 1) with a single die by varying the force 28 (shown in FIG. 1) that is applied to press media 26 into media embossing template 24, by using different force distribution media 38, and by attaching or removing foam or other substance 42 (shown in FIG. 2) that may be placed outside raised perimeter 32. In one embodiment, a user of non-apertured die 20 may emboss a raised perimeter 32 into media 26. In another embodiment, the figure or pattern defined by raised perimeter 32 may be cut into media 26. In still another embodiment, foam or other substance 42 may be used to align the edge 36 of raised perimeter 32 with the area of die outside of raised perimeter 32, such that embellishments are impressed on the area enclosed by raised perimeter 32 only. The embodiments discussed above may be further embossed by using additional force 28 to push media 26 into recessed embosser 34.

Media embossing template 24 can be formed using any die forming technology. For example, media embossing template 24 may be formed by machining and shaving away the unwanted areas of face 22 such that raised perimeter 32 and recessed embosser 34 are formed. In an alternative embodiment, media embossing template 24 may be formed by etching face 22 such that the unwanted areas of face 22 are chemically removed. One skilled in the art would recognize that although machining and etching methods of die forming are discussed, any other method of creating dies can be used to create media embossing template 24. Furthermore, one skilled in the art will recognize that when forming media embossing template 24, any combination of any method of creating dies can be used to imprint raised perimeter 32 and recessed embosser 34 into face 22.

The non-apertured nature of non-apertured die 20 provides the user with multiple options to customize, emboss and otherwise embellish media 26. By providing the tri-level embossing system that can be used to emboss and embellish a media 26, the user is provided with multiple options on a single die of how to personalize their works. The user can select to only cut or emboss an outline as provided by raised perimeter 32, or can select to cut or emboss outline and apply additional embellishments or embossments by applying greater force 28 and pressing media 26 into recessed embosser 34.

When using recessed embosser 34, the user is not limited to simply embossing media 26. In one embodiment, paints and/or other coloring media 26 may be used with media embossing template 24. The personalization afforded by using paints and/or other coloring media 26 can be implemented by applying paint and/or other coloring media 26 upon the entire area enclosed by raised perimeter 32 such that media 26 is colored by the paint and/or other coloring media 26 when media 26 is pressed into media embossing template 24. More localized colorization may be effected by applying paint and/or other coloring media 26 within recessed embosser 34. This provides the user with multiple colorable surfaces at different depths. The user may select to only color recessed embosser 34, only raised perimeter 32, only template base 30, or any combination of the three.

In summary, the present invention teaches a non-apertured die 20 with a media embossing template 24 on a face 22 to be used in papercraft and scrapbooking Media embossing template 24 has a raised perimeter 32 and a recessed embosser 34, reducing the number of dies that a user may have to possess to embellish and otherwise emboss media 26 as desired. Furthermore, non-apertured die 20 is designed to be used individually, thus removing the need of owning matching male and female dies to form the desired embossments and embellishments on media 26.

By providing a non-apertured die 20, the user is permitted to apply as much force 28 as necessary on media embossing template 24 to cause the desired embossment or embellishment on media 26. Also, the non-apertured nature of non-apertured die 20 permits non-apertured die 20 itself to have an increased thickness such that potential dangers of user injury due to sharp edges is reduced.

The embossing pattern of recessed embosser 34 can be used to provide not only embossment of the media 26, but also further embellishments. By painting or otherwise coloring recessed embosser 34 of media embossing template 24, non-apertured die 20 can paint and/or color media 26 as desired while, at the same time, embossing media 26. Thus, the user can better control the distribution of paint and/or other colors by painting or otherwise coloring media embossing template 24 of non-apertured die 20 and removing unwanted paint and/or color from media embossing template 24 prior to embossing media 26.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A dry media embossing template comprising:
a non-apertured die having a face configured to emboss a media, and comprising a raised perimeter and a recessed embosser;
wherein said raised perimeter and said recessed embosser are both configured to emboss said media.

2. A dry media embossing template as claimed in claim 1 wherein said raised perimeter comprises a two-dimensional embossing perimeter formed integrally with said non-apertured die, said two-dimensional embossing perimeter extending from said face.

3. A dry media embossing template as claimed in claim 2 wherein said raised perimeter further comprises a die cut blade.

4. A dry media embossing template as claimed in claim 2 wherein said raised perimeter is etched into said non-apertured die.

5. A dry media embossing template as claimed in claim 2 wherein said recessed embosser comprises an embossing pattern.

6. A dry media embossing template as claimed in claim 5 wherein said embossing pattern is enclosed within said raised perimeter.

7. A dry media embossing template as claimed in claim 1 wherein said recessed embosser comprises a uniform embossing pattern.

8. A dry media embossing template as claimed in claim 7 wherein said embossing pattern is etched into said non-apertured die.

9. A dry media embossing template as claimed in claim 1 wherein said non-apertured die is formed from an etched material.

10. A dry media embossing template as claimed in claim 9 wherein said non-apertured die is formed from metal.

11. A dry media embossing template as claimed in claim 1 wherein at least one of said raised perimeter or said recessed embosser is formed by machining said face.

12. A dry media embossing template as claimed in claim 11 wherein the remaining of said raised perimeter or said recessed embosser is formed by etching said face.

13. A dry media embossing template as claimed in claim 1 wherein:
said non-apertured die further comprises:
a media release enclosed within an area enclosed by said raised perimeter;
wherein said media release extends through said non-apertured die.

14. A dry media embossing template comprising:
a non-apertured die having a face configured to emboss a media; wherein:
said face comprises a raised perimeter and a recessed embosser;
said raised perimeter further comprises a two-dimensional embossing perimeter formed integrally with said non-apertured die, said two-dimensional embossing perimeter extending from said first surface; and
said recessed embosser comprising an embossing pattern having an outside perimeter of said raised embosser.

15. A dry media embossing template as claimed in claim 14 said raised perimeter comprises a die cut blade.
